(19) United States
(12) Patent Application Publication
(10) Pub. No.: US 2003/0154704 A1
(43) Pub. Date: Aug. 21, 2003

(54) Brush cutting breakaway system

(76) Inventor: Jimmie J. Dallman, Everett, WA (US)

Correspondence Address: Donna J. Thies, 790 Idylwood Dr., S.W., Issaquah, WA, 98027, US

(21) Appl. No.: 10/365,002

(22) Filed: Feb. 11, 2003

Related U.S. Application Data
(60) Provisional application No. 60/357,147, filed on Feb. 13, 2002.

(51) Int. Cl. A01D 34/03

(52) U.S. Cl. 56/14.7

(57) ABSTRACT

Multi-part improvements to brush cutting technology including a breakaway system. A single horizontal pin attaches the cutter head of a brush cutting machine to the boom and a swing tower, so that a single vertical pin can attach the tractor to the boom, the vertical pin and swing tower allowing the cutter head to have a forward and aft movement for flexibility around immovable objects. A breakaway cylinder holds the cutter head at a ninety degree angle relative to the tractor of a brush cutting machine. A control, in the form of a joystick, remotely raises and lowers the cutter head portion using a single control within the cab. A first relief valve bypasses when higher than normal hydraulic pressure is created in the breakaway cylinder and a second relief valve removes excess oil from the breakaway cylinder. A switch, in the form of a toggle switch, remotely operates the breakaway cylinder and moves the cutter head from within the cab. A method for brush cutting with a brush cutting machine having a breakaway system is also disclosed.

Applicant hereby claims priority of provisional patent application No. 60/357,147 filed on Feb. 13, 2002.

### BACKGROUND OF THE INVENTION

In brush cutting technology it has long been a problem that while cutting brush, when the blades of the mower or cutter head encounter an object that is difficult or impossible to move, the cutter head futilely continues to whack at the object because there is no option for moving the brush cutter head away from the object. If the cutter head continues to hit such an object, there can be damage to the cutter head, engine or other parts of the brush cutting machine. Also, the shock of hitting this type of object is absorbed by the cab of the tractor which is physically difficult for the operator and can damage the frame of the tractor or cutter head frame. This is particularly true in the use of a shoulder or wing type of brush cutting machine, so named because it is adapted to cut the shoulder area of a highway or road, where unknown immovable objects such as rocks or stumps may appear at any time. A shoulder or wing type of brush cutting machine presents a particular problem because the boom in such a brush cutting machine is very short and close to the tractor. It is therefore particularly difficult to fit the mechanics required for a brush cutting breakaway into the smaller space of the boom of the shoulder or wing type of brush cutting machine, requiring improved design to include the necessary mechanics, linkages and pivot points within the space limitations of the shoulder or wing type of brush cutting machine. When the cutter head of a shoulder type brush cutting machine hits an immovable object in the prior art, the brush cutting operator is at the mercy of the situation and after whacking at the object, the tractor of the brush cutting machine would have to be backed up and the immovable object avoided on a second pass. This is time consuming, inconvenient and not fuel efficient for the brush cutting machine. Also, often in the prior art, a directional control valve used as the valve associated with a switch, is a hydraulic-only valve which requires that a lever integral to the valve be manually moved. Thus, it would be necessary to have very hot hydraulic fluid under high pressure within inches of the operator.

What is desired then is a simple, convenient and inexpensive way for the brush cutting machine to raise and lower a mower or cutter head, to give the mower or cutter head a forward and aft motion, to respond to the above described situation and for the blades of the mower or cutter head to breakaway from an offending object.

### SUMMARY OF THE INVENTION

In order to overcome problems inherent in the prior art, there has been devised by the present invention multi-part improvements over conventional brush cutting technology and in particular in a shoulder type of brush cutting machine. First, in the present invention the mower or cutter head portion of a brush cutting machine is attached to the boom and a swing tower by a single horizontal pin at each location. This makes it possible to install a vertical pin for the second improvement. In the second improvement of the present invention the boom is attached to the tractor of the brush cutting machine by the single vertical pin. This allows the mower or cutter head portion of the brush cutting machine to have a forward and aft movement, not previously available in the prior art.

Third, the present invention includes a swing tower which gives the mower or cutter head portion of a brush cutting machine the ability to swing forward and aft. This is an improvement over the prior art in that prior art brush cutting machines allow the mower or cutter head portion of the brush cutting machine to only be at a ninety-degree angle relative to the tractor portion of the brush cutting machine. The swing tower portion of the present invention allows the mower or cutter head portion of the brush cutting machine to also swing forward and aft, giving the mower or cutter head portion of the brush cutting machine much greater flexibility in moving around a difficult object by moving ahead of or behind the object without having to reposition the brush cutting machine as much as previously required.

Fourth, the present invention includes a breakaway cylinder which holds the blades of the mower or cutter head portion of a brush cutting machine at a ninety-degree angle relative to the tractor portion of the brush cutting machine until the cutter head portion comes into contact with an object that is not easily moved. This portion of the multi-part improvements of the present invention is an improvement over the prior art in that in prior art brush cutting machines the mower or cutter head is rigidly positioned at a ninety-degree angle relative to the tractor portion of the brush cutting machine with no other options. The breakaway cylinder of the present invention allows the mower or cutter head to be at an angle other than ninety degrees relative to the tractor portion of the brush cutting machine also providing the brush cutting machine with greater flexibility and maneuvering capabilities.

Fifth, the present brush cutting breakaway system of the present invention includes a control, generally in the form of a joystick, used to raise and lower the cutter head of the brush cutting machine within the cab of the brush cutting machine. The joystick controls a fold up cylinder and a lift cylinder. The lift cylinder lifts and lowers the cutter head. This is an improvement over the switches of the prior art, since the single joystick of the present invention replaces as many as four switches in the prior art that would be located in several locations. The joystick is mounted at a position in the cab where all functions are conveniently available at the operator's finger tips for remotely raising and lowering the cutter head of the brush cutting machine.

Sixth, the present invention includes two relief valves, one of which is pre-set to a lower pressure than the other relief valve. The breakaway cylinder operates when there is additional pressure created by the mower or cutter head when the mower or cutter head comes into contact with an object that is not easily moved. The two relief valves are pre-set to bypass under the additional pressure condition created by the mower or cutter head of a brush cutting machine coming into contact with an object that is not easily moved. In this event, as the brush cutting machine carrying the mower or cutter head moves back because of the object, hydraulic pressure is applied to the piston side of the breakaway cylinder whereupon hydraulic fluid is moved from the piston side of the breakaway cylinder to a first of the two relief valves. From the first of the two relief valves, hydraulic fluid moves to the second of the two relief valves and back to the rod side of the breakaway cylinder thereby equalizing pressure in the breakaway cylinder, whereby the breakaway cylinder can operate, moving the cutter head aft to a position of more or less than ninety degrees relative to the tractor portion of the brush cutting machine, avoiding damage to the brush cutter, mower or cutter head, or blades. If the two relief valves were not in the system to equalize hydraulic pressure, the brush cutting machine and mower or cutter head would have no counter balancing pressure and would continue to whack futilely against an offending object, thereby causing damage to the brush cutter engine, mower or cutter head, or blades.

Seventh, the present invention includes a control valve, which is a directional control valve that is electrically operated by a switch, generally in the form of a toggle switch, located at the base of the joystick. The toggle switch allows the operator of the brush cutting machine to move the mower or cutter head back to a ninety-degree angle relative to the tractor of the brush cutting machine after the mower or cutter head has been successfully negotiated around a troublesome object. Typically, in the prior art, after the mower or cutter head has cleared the object, the operator would step on a clutch and brake causing the brush cutting machine to stop. Then, the operator would place the transmission in reverse, let off the brake and clutch, moving the tractor back from the troublesome object. Then, the operator would step on the clutch and brake and place the transmission back into the forward position, again letting out the brake and clutch, starting the brush cutting machine forward once again. In using the present invention, however, if all of the breakaway cylinder movement to the aft direction is not used, the operator can move the cutter head further aft, then raise the cutter head, drive forward past the troublesome object, bring the cutter head forward to its original ninety-degree angle relative to the tractor of the brush cutting machine, and then lower the cutter head and continue on, thereby minimizing the need to back up and start again. The breakaway cylinder ordinarily allows the cutter head to swing backward in an arc of around six to eight feet. So, if all of the breakaway cylinder movement is not used in the present invention, the operator can move the cutter head the remaining distance by moving the toggle switch within the tractor. As the operator moves the toggle switch forward causing hydraulic fluid to return to the piston side of the breakaway cylinder, hydraulic fluid is also thereby caused to go back from the rod side of the breakaway cylinder and back into the hydraulic system, which returns the mower or cutter head to its original ninety-degree angle relative to the tractor of the brush cutting machine. This is also an improvement over the prior art in that in the prior art, the mower or cutter head can only stay at a ninety-degree angle relative to the tractor portion of the brush cutter and to clear an object the whole tractor portion of the brush cutting machine must be moved to maneuver around the object. The type of electrically operated valve used in the present invention, an electronic over hydraulic valve, also eliminates the need to have very hot oil under high pressure within inches of the operator, in the cab of the brush cutting machine.

### BRIEF DESCRIPTION OF THE DRAWINGS

FIG. 1 is a side environmental view showing the features of the present invention positioned within a brush cutting machine.

FIG. 2 is a cross-sectional view taken through lines 2-2 of FIG. 1 showing the arrangement of the parts of the present invention.

FIG. 3 is a top view of the present invention showing the brush cutting breakaway in an inactive state.

FIG. 4 is a top view of the present invention showing the brush cutting breakaway when it encounters an immovable object and the cutter head is raised from the object.

FIG. 5 is a top view of the present invention showing the brush cutting breakaway after the cutter head is being returned to a ninety-degree angle relative to the tractor portion of the brush cutting machine.

FIG. 6 is a schematic view showing in general how the two relief valves of the present invention operate.

FIG. 7 is a schematic view showing the breakaway cylinder, the two relief valves and the directional control valve as they work together in the present invention.

### DESCRIPTION OF THE PREFERRED EMBODIMENT

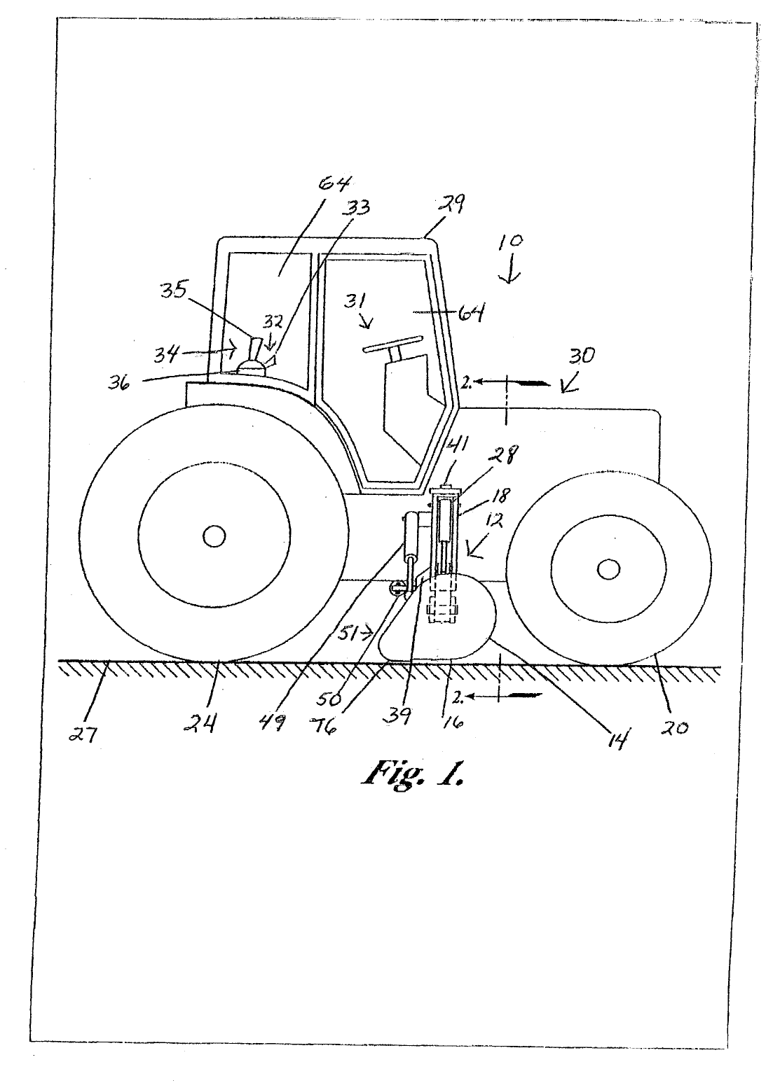

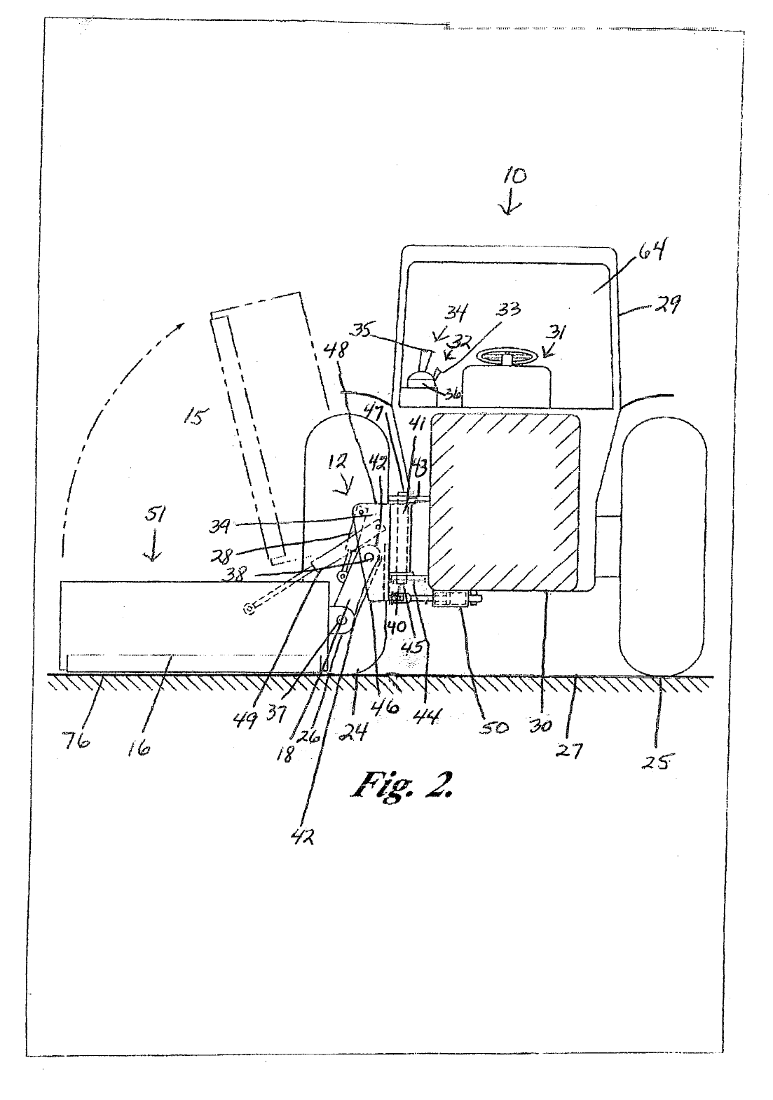

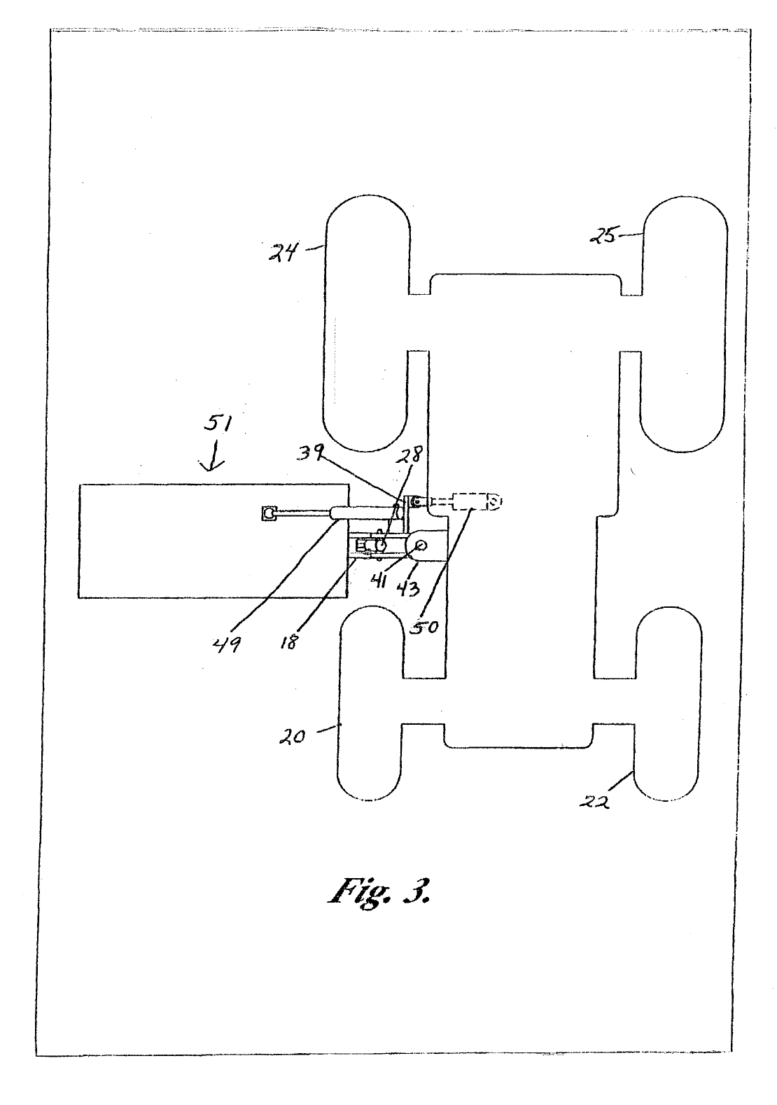

Referring now to the drawings in general and to FIG. 1 in particular, there is shown a side environmental view showing the features of the present invention positioned within a brush cutting machine. The brush cutting machine as seen in FIG. 1 is shown generally by the number 10 and the brush cutting breakaway of the present invention is shown generally by the number 12. The brush cutting machine 10 as seen in FIG. 1 has a flail cutter 14 as the cutter head 16, the flail cutter 14 being seen from the side in FIG. 1, with parts of the present invention shown in dashed lines within. The flail cutter 14 as seen in FIG. 1 is shown by way of example only, and it is to be understood that the use of any kind of cutter head 16 is within the spirit and scope of the invention. The type of boom 18 shown in FIG. 1 is a shoulder or wing type boom as used more usually with the present invention, however, it is also within the spirit and scope of the invention to use the present invention with other types of booms, such as a swing boom. The brush cutting machine 10 has two front tires 20 and 22, as seen most clearly in FIGS. 3, 4, and 5, with only one front tire 20 visible in the side view of FIG. 1. The brush cutting machine 10 has two rear tires 24 and 25, also as seen most clearly in FIGS. 3, 4, and 5, with only one rear tire 24 being visible in the side view of FIG. 1 as well. Positioned between the showing front tire 20 and the showing rear tire 24 is positioned the boom 18, which carries some sort of cutter head 16 attached to a first end 26 of the boom 18 closest to the ground 27, as seen most clearly in FIG. 2. The boom 18 is a lift-type boom, which allows the cutter head 16 to be moved up and down by means of the lift cylinder 28 attached to the boom 18. Within the cab 29 of the tractor portion 30 of the brush cutting machine 10 are the usual steering parts 31 of the tractor, some are not shown in FIG. 1, and a switch 32, generally in the form of a toggle switch 33, and a control 34, generally in the form of a joystick 35. One of the purposes of the toggle switch 33, is to allow the operator of the brush cutting machine 10 the ability to move the cutter head 16 to an angle of ninety degrees relative to the brush cutting machine 10. One of the purposes of the joystick 35 is to operate the lift cylinder 28 to thereby lift and lower the cutter head 16. The single joystick 35 of the present invention replaces as many as four switches in the prior art that would be located in various locations. The joystick 35 is mounted at a position in the cab 29 where all functions are conveniently available for remotely raising and lowering the cutter head 16 of the brush cutting machine 10. The toggle switch 33 is in the same general location as the joystick 35, generally at a convenient location to the operator. The toggle switch 33 is usually positioned at the base 36 of the joystick 35, but another convenient location would also be within the spirit and scope of the invention.

Referring now to FIG. 2 of the drawings, there is shown a cross-sectional view taken through line 2-2 of FIG. 1 showing the arrangement of the parts of the present invention. The multi-part improvements of the present invention include first horizontal pins 37 and 38, the first horizontal pin 37 attaches the cutter head 16 to the boom 18, and the second horizontal pin 38 attaches the cutter head 16 to a swing tower 39, a third vertical pin 40, which is a forward and aft pivot 41, that attaches the boom 18 to the tractor portion 30, and the swing tower 39, as seen most clearly in FIG. 2. The swing tower 39 is attached to the boom 18 at the end 42 of the boom 18 opposite to the first end 26 of the boom 18 that has the cutter head 16 attached. The lift cylinder 28 hinges on the upper end 42 of the boom 18 and raises the cutter head 16 up and down. The boom 18 is connected to the tractor portion 30 of the brush cutting machine 10 by means of an upper mounting plate 43 and a lower mounting plate 44 positioned also around the forward and aft pivot 41. The swing tower 39 of the present invention allows the cutter head 16 of the brush cutting machine 10 to swing forward and aft giving the brush cutting machine 10 greater flexibility and maneuvering capabilities. The swing tower 39 includes the forward and aft pivot 41 connected at its first end 45 to a position near the bottom 46 of the swing tower 39, and connected at its second end 47 to the tractor portion 30 of the brush cutting machine 10. The swing tower 39 does not allow the cutter head 16 to go in the aft direction far enough that would allow the cutter head 16 to come into contact with the rear tire 24 of the brush cutting machine 10. Positioned near the top 48 of the swing tower 39 is a fold up cylinder 49. The fold up cylinder 49 has the function of allowing the cutter head 16 to be moved up and down, or to be stood up straight. The fold up cylinder 49 hinges on the first horizontal pin 37 and lifts and lowers the cutter head 16.

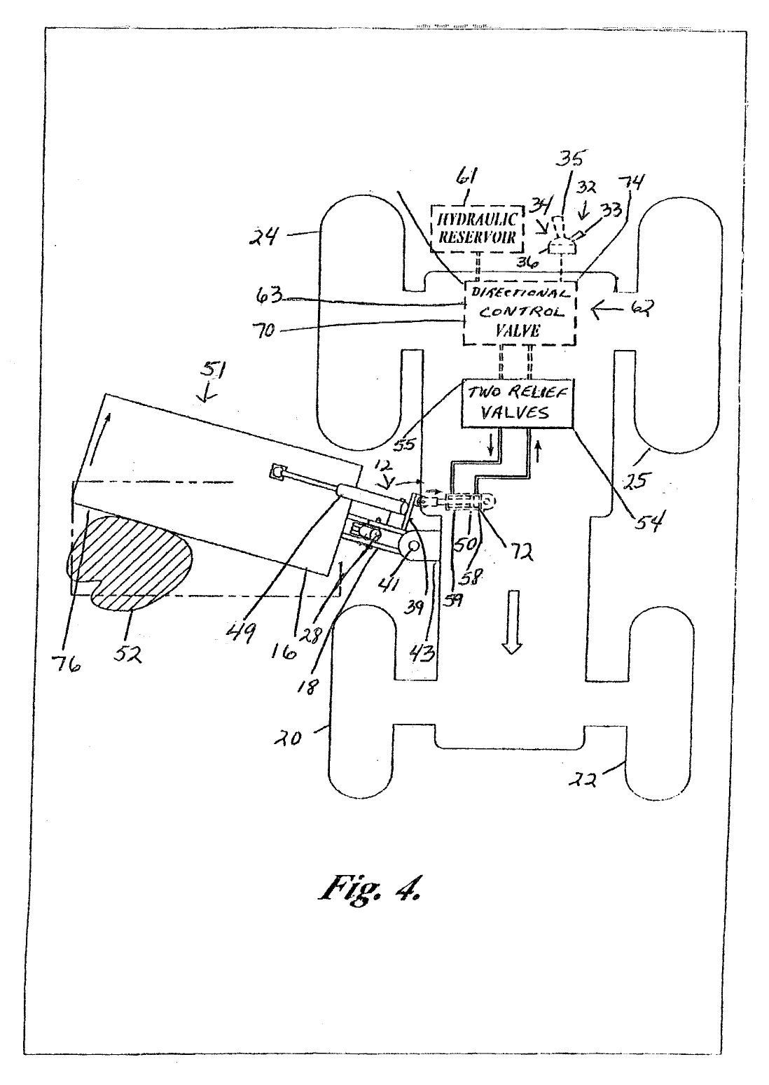

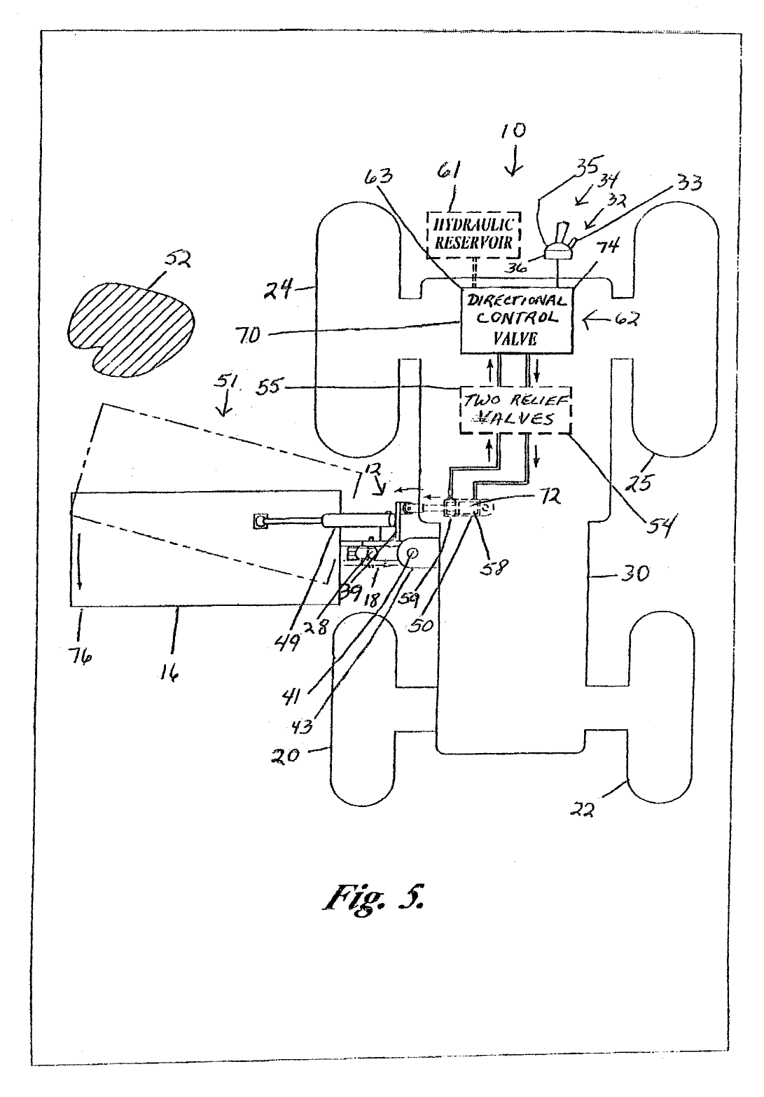

The multi-part improvements of the present invention further includes a breakaway cylinder 50, as seen most clearly in FIGS. 2, 3, 4, and 5, which is attached to the second end 47 of the forward and aft pivot 41. The breakaway cylinder 50 holds the mower or cutter head portion 51 of the brush cutting machine 10 at a ninety degree angle relative to the tractor portion 30 of the brush cutting machine 10 until the cutter head portion 51 comes into contact with an object 52, as seen in FIGS. 4 and 5, that is not easily or is impossible to be moved. When the cutter head portion 51 hits the object 52, the breakaway cylinder 50 trips causing unequal hydraulic pressure within the brush cutting breakaway 12, and as the hydraulic pressure equalizes within the present invention, it allows for the cutter head 16 to move at an angle other than ninety degrees relative to the brush cutting machine 10.

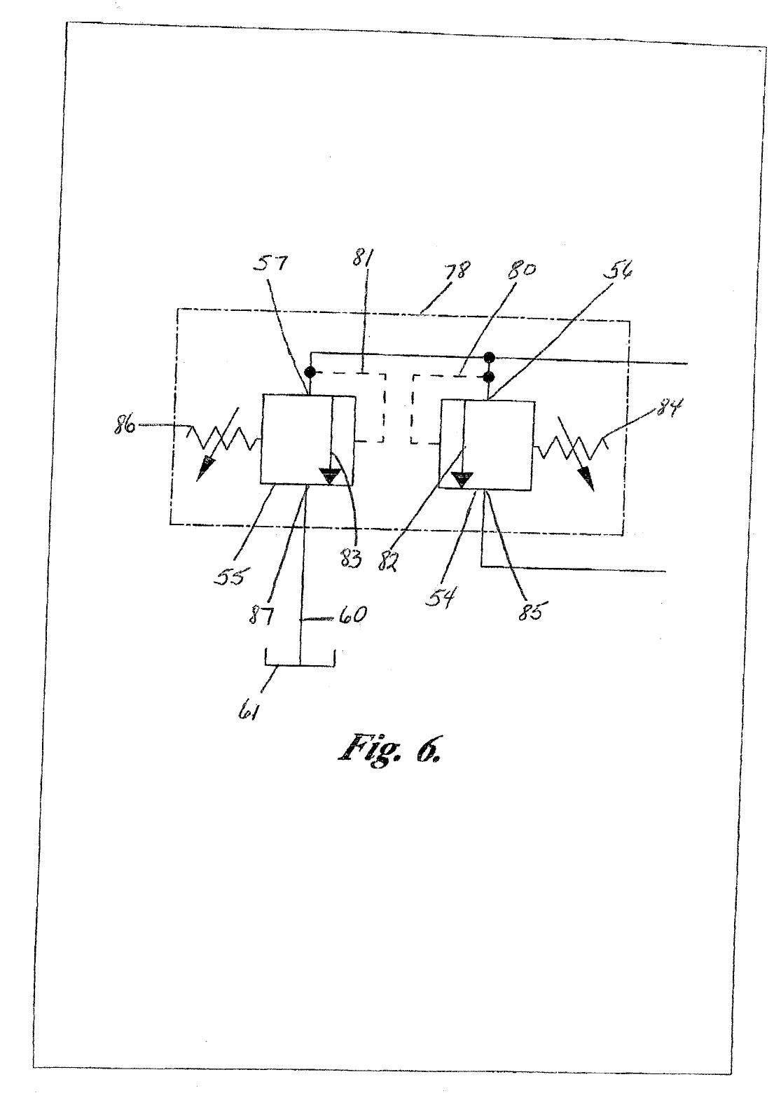

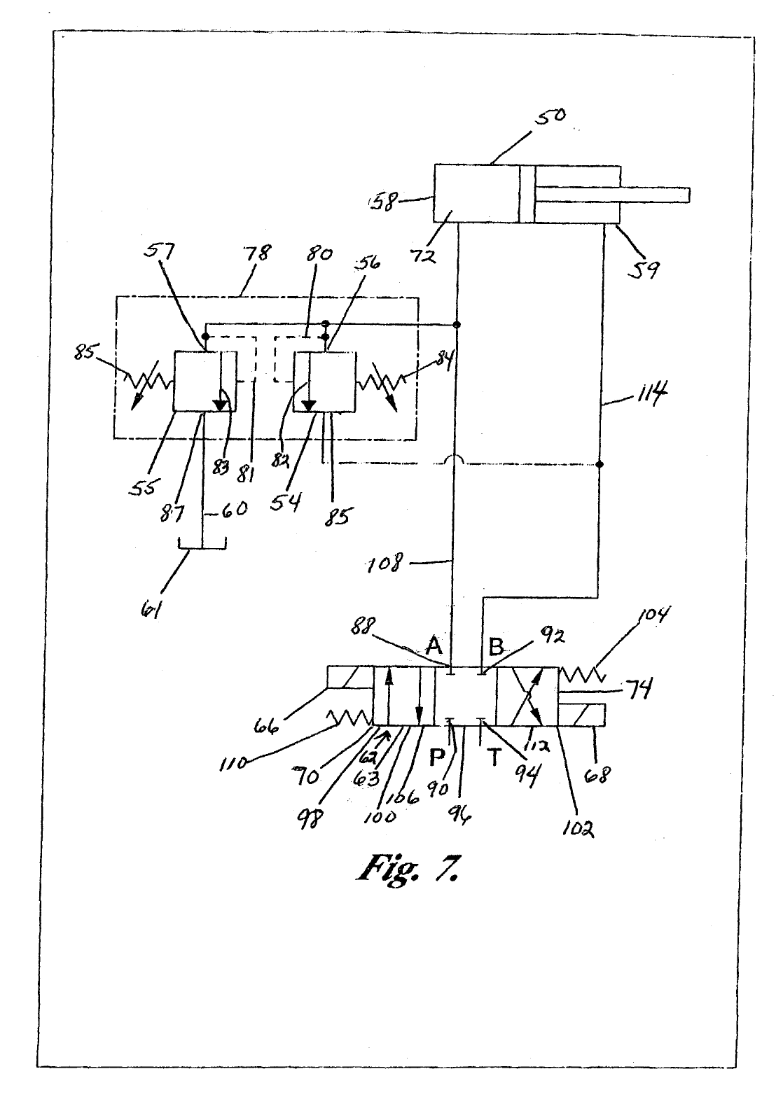

Another aspect of the present invention includes the two relief valves 54 and 55, as seen most clearly in FIGS. 4, 5, and 6, and as explained with reference to FIG. 6, that has the first relief valve 54 pre-set at a pressure lower than the second relief valve 55 so that it bypasses when there is the higher than normal hydraulic pressure created in the breakaway cylinder 50 when the cutter head 16 hits an immovable object 52, as seen in FIGS. 4 and 5. At this time, hydraulic pressure increases at the inlet sides 56 and 57 of the two relief valves 54 and 55, as seen most clearly in FIG. 6. When the pressure reaches the pressure set point of the first relief valve 54 of the two relief valves 54 and 55, hydraulic fluid circulates from the piston side 58 of the breakaway cylinder 50 to the rod side 59 of the breakaway cylinder 50,as seen in FIGS. 4 and 7, allowing the cutter head 16 to move to an angle other than ninety degrees relative to the brush cutting machine 10, as seen in FIGS. 2 and 4. Since the piston side 58 of the breakaway cylinder 50 holds a larger volume of hydraulic fluid than the rod side 59 of the breakaway cylinder 50, the relief valve 55 of the two relief valves 54 and 55 is connected to a line 60 that allows the excess hydraulic fluid from the piston side 58 of the breakaway cylinder 50 to return to the hydraulic reservoir 61, as seen in FIG. 7. This transfer of hydraulic fluid within the breakaway cylinder 50 allows the breakaway cylinder 50 to operate. This allows the cutter head 16 to move to an angle other than ninety degrees relative to the tractor portion 30 of the brush cutting machine 10 and then the operator can return the cutter head 16 to an angle of ninety degrees relative to the tractor portion 30 of the brush-cutting machine 10. This aspect of the present invention is most clearly shown in FIGS. 6 and 7.

A further aspect of the present invention includes the switch 32, generally in the form of a toggle switch 33, which operates a control valve 62, generally in the form of a directional control valve 63, as seen most clearly in FIG. 4. When the operator in the interior 64 of the cab 29 of the tractor portion 30 of the brush cutting machine 10, as seen most clearly in FIG. 1, moves the switch 32 forward, the directional control valve 63, as seen most clearly in FIGS. 4, 5, and 7, directs hydraulic flow to the piston side 58 of the breakaway cylinder 50 and allows hydraulic fluid to go back from the rod side 59 of the breakaway cylinder 50 and back into the hydraulic reservoir 61, as seen most clearly in FIG. 5. The cutter head 16 is thereby returned to a ninety-degree angle relative to the tractor portion 30 of the brush cutter 10. The type of directional control valve 63 used in this aspect of the present invention is an electronic over hydraulic valve used with electronic switches. The electric current supplied by the switch 32 activates a solenoid 66 or 68, as seen in FIG. 7, that opens or closes as the electrical current is applied by moving the switch 32 forward or backward, as seen most clearly in FIGS. 4 and 5. When the control 32 is in the neutral position, there is no electrical current directed to the first side 70 of the directional control valve 63, thus it is closed. This aspect of the present invention is best shown in FIG. 7. This particular type of directional control valve 63 is used in this invention because when there is an electronic over hydraulic valve used, it is not required that an operator manually use a lever to activate it, thereby eliminating the necessity of having very hot hydraulic fluid under high pressure within inches of the operator, in the cab 29 of the brush cutting machine 10. It would however, be within the spirit and scope of this invention to use a manually controlled lever instead of an electronic over hydraulic valve.

FIG. 3 is a top view of the present invention showing the brush cutting breakaway in an inactive state.

FIG. 4 is a top view of the present invention showing the brush cutting breakaway 12 when it encounters an immovable object 52 and the cutter head 16 is raised from the object 52. It can be seen in FIG. 4 that as the cutter head 16 encounters an immovable object 52, the forward and aft pivot 41 which is attached to the swing tower 39 and held at a ninety degree position relative to the tractor portion 30 by the breakaway cylinder 50, causes the cutter head 16 to be moved in the aft direction as the tractor portion 30 moves by the object 52. This motion by the forward and aft pivot 41 causes the breakaway cylinder 50 to collapse, whereby the additional hydraulic pressure thus created moves through the first relief valve 54 as previously described thereby equalizing hydraulic pressure in the brush cutting breakaway 12. The collapse of the breakaway cylinder 50 is controlled by the two relief valves 54 and 55 because the two relief valves 54 and 55 can be pre-set at any desired pressure that would allow the piston 72 of the breakaway cylinder 50 to move.

FIG. 5 is a top view of the present invention showing the brush cutting breakaway 12 after the cutter head 16 is being returned to a ninety-degree angle relative to the tractor portion 30. In FIG. 5 it can be seen that after the cutter head 16 has moved away from the immovable object 52, the reverse of what happens in FIG. 4 happens in FIG. 5. Thus, the forward and aft pivot 41 attached to the swing tower 39 allows the cutter head 16 to be returned to the ninety-degree angle position relative to the tractor portion 30 of the brush cutting machine 10 that it was in prior to encountering the object 52. When the operator in the interior 64 of the cab 29, as seen in FIG. 1, of the tractor portion 30 of the brush cutting machine 10 moves the toggle switch 33 forward, hydraulic fluid is thus put back on the piston side 58 of the breakway cylinder 50 forcing hydraulic fluid from the rod side 59 of the breakaway cylinder 50, which moves the piston 72 of the breakaway cylinder 50 toward the rod side 59 of the breakaway cylinder 50. The hydraulic fluid then moves from the rod side 59 of the breakaway cylinder 50 through the inlet side 57 of the second relief valve 55 and back into the hydraulic reservoir 61, as seen in FIGS. 6 and 7. This process can also be seen in FIG. 7. In operation then, as the operator moves the toggle switch 33 in the direction that is desired in order to move the cutter head 16, a measured amount of voltage is sent to the directional control valve 63 on the first side 70 of the directional control valve 63, flowing through to the second side 74 of the directional control valve 63. The directional control valve 63 is opened a measured distance in relation to the measured voltage received from the first side 70 of the directional control valve 63. So, the directional control valve 63 works like a rheostat in that the greater distance the toggle switch 33 is moved, the greater distance the directional control valve 63 is opened. When moving the toggle switch 33 in the direction that will open the directional control valve 63, hydraulic fluid is allowed to flow from the directional control valve 63 through the two relief valves 54 and 55 and into the breakaway cylinder 50, thereby moving the cutter head 16 to the desired cutting position. When the distal end 76 of the cutter head 16 comes against an immovable object 52, pressure builds on the piston side 58 of the breakaway cylinder 50 causing the hydraulic fluid on the piston side 58 of the breakaway cylinder 50 to move to the rod side 59 of the breakaway cylinder 50. When this occurs, the distal end 76 of the cutter head 16 has moved rearward. To return the cutter head 16 back to the position of ninety degrees relative to the tractor portion 30 of the brush cutting machine 10, the toggle switch 33 is moved in the appropriate direction to correspond to the direction that is desired to move the cutter head 16.

Referring now to FIG. 6, there is shown a schematic view of the two relief valves 54 and 55 of the present invention, showing the two relief valves 54 and 55 in a static state and showing generally how the two relief valves 54 and 55 of the present invention operate. The outer perimeter 78 of the schematic of FIG. 6 indicates that there are two relief valves 54 and 55 in a single block. As indicated hereinbefore, as pressure builds in the-first valve 54, hydraulic fluid relieves to the other valve 55, so that higher pressure relieves hydraulic fluid to the lower side. The first relief valve 54 is open all the time until pressure equalizes between the two relief valves 54 and 55, then both relief valves 54 and 55 close. The dashed lines 80 and 81 in FIG. 6 represent pilot lines where internal pressure readings are made at the inlet sides 56 and 57 of relief valves 54 and 55 respectively. Pressure against the arrow 82 in the first relief valve 54 works against the spring 84 of the first relief valve 54 and then connects the inlet side 56 of the first relief valve 54 to the outlet side 85 of the first relief valve 54. Similarly, the pilot line 81 connotes that pressure is applied against the arrow 83 in the second relief valve 55 which works against the spring 86 in the second relief valve 55 to thereby connect the inlet side 57 of the second relief valve 55 to the outlet side 87 of the second relief valve 55. The purpose of the two relief valves 54 and 55 is to bypass under the additional pressure condition created by the cutter head 16 of a brush cutting machine 10 coming into contact with an object 52 that is not easily moved. It is within the spirit and scope of the invention that any arrangement of parts that will accomplish this objective can be used. The two relief valves 54 and 55 as shown in FIG. 6 are used by way of example only. In the two relief valves 54 and 55 as shown in FIG. 6, it is necessary that the pressure in the first relief valve 54 be set at a lower pressure than the pressure in the second relief valve 55. The springs 84 and 86 associated with the relief valves 54 and 55 indicate that the pressure setting for each relief valve 54 and 55 is adjustable. As the cutter head 16 of the brush cutting machine 10 comes into contact with an immovable object 52 the cutter head 16 moves back from the object 52, as seen in FIG. 5. In this event, hydraulic fluid that has come into the inlet side 56 of the first relief valve 54 from the piston side 58 of the breakaway cylinder 50, through the first relief valve 54 and out from the outlet side 85 of the first relief valve 54 circulates to the rod side 59 of the breakaway cylinder 50 until the hydraulic fluid cannot push the piston 72 of the breakaway cylinder 50 any farther, as seen most clearly in FIG. 7. Then, overflow hydraulic fluid relieves from the piston side 58 of the breakaway cylinder 50 to the inlet side 57 of the second relief valve 55 and back through the outlet side 87 of the second cylinder 55 and to the system as symbolized by the hydraulic reservoir 61.

Referring now to FIG. 7 of the drawings, there is shown a schematic view of the two relief valves of FIG. 6, the directional control valve, and the breakaway cylinder of the present invention. The purpose of the directional control valve 63 is to respond to movement of a toggle switch 33 within the cab 29 of the tractor portion 30 to move the mower or cutter head 16 back to a ninety-degree angle relative to the tractor portion 30 of the brush cutting machine 10 after the mower or cutter head 16 has been successfully negotiated around a troublesome object 52, as seen in FIGS. 4 and 5. In a manner similar to that stated with regard to the two relief valves 54 and 55, it is within the spirit and scope of the invention that any arrangement of parts that will accomplish the above objective can be used and the directional control valve 63 as shown in FIG. 7 is also used by way of example only. In FIG. 7 the directional control valve 63, which is an electrically operated valve, is used in combination with the two relief valves 54 and 55 as shown and described with reference to FIG. 6. If the brush cutting breakaway 12 of the present invention, as seen in FIG. 5, is in neutral, the solenoids 66 and 68 are de-energized and all ports 88, 90, 92 and 94 are blocked, whereby the directional control valve 63 is in its center position 96. The A side 98 of the directional control valve 63 is also marked with a P on the input side 100 of the directional control valve 63 to indicate pressure or the source of hydraulic flow. And the B side 102 of the directional control valve 63 is also marked with a T to indicate tank or hydraulic fluid return. Upon activation, as when the toggle switch 33 in the cab 29, as seen in FIG. 1, is moved forward, the A side solenoid 66 in the directional control valve 63 works against the spring 104 on the B side 102 of the directional control valve 63. Therefore, as the A side solenoid 66 caused movement against the spring 104 on the B side 102, the directional control valve 63 moved to the A position 106 which is on the A side 98 of the directional control valve 63, where P is connected to A and B is connected to T, allowing hydraulic fluid flow through the A pipe 108 to the two relief valves 54 and 55 and further flows as described with reference to FIG. 6. The opposite is true when the toggle switch 33 in the cab 29, as seen in FIG. 1, is moved rearward. That is, the B side solenoid 68 in the directional control valve 63 works against the spring 110 on the A side 98 of the directional control valve 63. As the B side solenoid 68 causes movement against the spring 110 on the A side 98, the directional control valve 63 moves to the B position 112 which is on the B side 102 of the directional control valve 63, where T is connected to A, and P is connected to B, allowing hydraulic fluid flow through the B pipe 114 to the breakaway cylinder 50.

Having described my invention, I claim:

1. A breakaway system for a brush cutting machine, the brush cutting machine having a cab, a tractor, a cutter head, and a boom, the boom having a first and second ends, the system comprising:
a) a first horizontal pin for attaching the cutter head to the boom;
b) a second horizontal pin for attaching the cutter head to a swing tower;
c) a vertical pin for attaching the boom to the tractor of the brush cutting machine to allow forward and aft movement of the cutter head;
d) the swing tower attached to the boom at the second end of the boom for swinging the cutter head in a forward and aft motion;
e) a breakaway cylinder for allowing the cutter head to move at an angle other than ninety degrees relative to the brush cutting machine; and,
whereby the system allows a brush cutting machine to be moved away from an immovable object as it comes in contact with the object.

2. The breakaway system for a brush cutting machine as defined in claim 1 further comprising:
a) a switch positioned within the cab of the brush cutting machine for remotely operating the breakaway cylinder and for remotely moving the cutter head of the brush cutting machine.

3. The breakaway system for a brush cutting machine as defined in claim 2 wherein the switch is a toggle switch.

4. The breakaway system for a brush cutting machine as defined in claim 1 further comprising:
a) a control positioned within the cab of the brush cutting machine for remotely raising and lowering the cutter head.

5. The breakaway system for a brush cutting machine as defined in claim 4 wherein the control is a joystick.

6. The breakaway system for a brush cutting machine as defined in claim 1 further comprising:
a) a first relief valve that bypasses when higher than normal hydraulic pressure is created in the breakaway cylinder;
b) a second relief valve for removing excess oil from the breakaway cylinder.

7. The breakaway system for a brush cutting machine as defined in claim 1 further comprising:
a) a directional control valve for returning the cutter head back to a ninety degree angle relative to the brush cutting machine.

8. The breakaway system for a brush cutting machine as defined in claim 7 wherein the directional control valve is an electronic over hydraulic valve.

9. A method for brush cutting with a brush cutting machine having a breakaway system, the brush cutting machine having a cab, a tractor, a cutter head, and a boom, the boom having a first and second ends, the method comprising the steps of:
a) providing a first horizontal pin for attaching the cutter head to the boom;
b) providing a second horizontal pin for attaching the cutter head to a swing tower;
c) providing a vertical pin for attaching the boom to the tractor of the brush cutting machine to allow forward and aft movement of the cutter head;
d) providing the swing tower attached to the boom at the second end of the boom for swinging the cutter head in a forward and aft motion;
e) providing a breakaway cylinder for allowing the cutter head to move at an angle other than ninety degrees relative to the brush cutting machine; and,
whereby the system allows a brush cutting machine to be moved away from an immovable object as it comes in contact with the object.

10. The method for brush cutting as defined in claim 9 further comprising the step of:
a) providing a switch positioned within the cab of the brush cutting machine for remotely operating the breakaway cylinder and for remotely moving the cutter head of the brush cutting machine.

11. The method for brush cutting as defined in claim 10 wherein the switch is a toggle switch.

12. The method for brush cutting as defined in claim 9 further comprising the step of:
a) A control positioned within the cab of the brush cutting machine for remotely raising and lowering the cutter head.

13. The method for brush cutting as defined in claim 12 wherein the control is a joystick.

14. The method for brush cutting as defined in claim 9 further comprising the steps of:
a) providing a first relief valve that bypasses when higher than normal hydraulic pressure is created in the breakaway cylinder;
b) providing a second relief valve for removing excess oil from the breakaway cylinder.

15. The method for brush cutting as defined in claim 9 further comprising:
a) providing a directional control valve for returning the cutter head back to a ninety degree angle relative to the brush cutting machine.

16. The method for brush cutting as defined in claim 15 wherein the directional control valve is an electronic over hydraulic valve.
